(19) United States
(12) Patent Application Publication
(10) Pub. No.: US 2009/0285376 A1
(43) Pub. Date: Nov. 19, 2009

(54) METHOD AND TOOLING FOR THE DEVELOPMENT OF TELECOM SERVICES

(75) Inventors: Shiri Kremer-Davidson, Yavniel (IL); Alan Hartman, Haifa (IL); Mila Keren, Nesher (IL); Dmitri Pikus, Haifa (IL)

Correspondence Address: CONNOLLY BOVE LODGE & HUTZ LLP, 1875 EYE STREET, N.W., SUITE 1100, WASHINGTON, DC, 20006, US

(73) Assignee: IBM, Yorktown Heights, NY (US)

(21) Appl. No.: 12/119,588

(22) Filed: May 13, 2008

(51) Int. Cl. H04M 3/42

(52) U.S. Cl. 379/201.03

(57) ABSTRACT

A method of telecom software and service development that allows a user to model and create telecom services independent of telecommunications protocols and network layer details. The method of the invention operates by creating an abstract model of a desired telecom service or services that is converted, using a set of extensible transformations, into executable code. Models in accordance with the method are constructed using an Integrated Development Environment (IDE) for creating and developing telecom services that is embodied in the Telecom Service Domain specific Language (TS-DSL)

### BACKGROUND

The present invention relates to the modeling and creation of telecommunications software and services. The telecommunications industry is rapidly evolving and expanding and new technologies are constantly being developed and introduced. These technologies create opportunities to develop services of value to customers. However, the pace at which these technologies are being introduced also means that service providers must be able to quickly respond and adapt to meet customer requirements.

Typically, the development of telecom services is performed by individuals with detailed knowledge of telecom protocols and software programming. The development process can be complicated and time consuming and often requires collaboration between programmers and telecom domain experts to properly address the programming details required in the development of services. Moreover, programming protocols in the telecom domain are fast changing with new ones being frequently introduced thereby requiring skilled individuals to continually update their knowledge base.

In view of the time, expertise, and expense typically required for programming development of telecom services, and the ever-changing nature of telecom programming protocols, it is desirable to have a telecom services development tool that permits the development of telecom services without the need for specialized knowledge of programming protocols, software and the like.

### SUMMARY

The present invention is directed to a method of telecom software and service development that allows a user to model and create telecom services independent of telecommunications protocols and network layer details. The method of the invention operates by creating an abstract model of a desired telecom service or services that is converted, using a set of extensible transformations, into executable code. Models in accordance with the method of the invention are constructed using an Integrated Development Environment (IDE) for creating and developing telecom services that embodies the Telecom Service Domain specific Language (TS-DSL) which is implemented as a Unified Modeling Language (UML) extension for the telecom domain. By this method, individuals without specialized knowledge of telecom services and related software programming and protocols can successfully design and implement telecom services. The ease of implementation of the method also reduces design time and, therefore, time to market of the finished product.

An embodiment of the invention is a method for the creation of telecom services comprising selecting predefined model parts related to specific services and expressed in Domain Specific Language; assembling the predefined static and behavioral model parts into an abstract model of desired telecom services; and automatically transforming the abstract model into executable code, wherein the automatically transforming step comprises an algorithm that maps at least one of structural and behavioral elements of at least one of Activity and State machine diagrams into at least one of executable Java code and elements required to create a telecom service solely based on the abstract model.

Further, in the above embodiment of the invention, the predefined model parts comprise portions of typical telecom services and elements including state machines describing service behavior, service specification as a black box and an additional place holder for implementing the service as a white box.

Further, in the above embodiment the Domain specific language is implemented as a UML profile and a model library with Telecom specific abstractions of general modeling elements, and pre-compiled run time blocks that can be used together with other model elements.

Further, in the above embodiment automatically transforming the abstract model further comprises using a special combination of code generated by the model parts and of pre-compiled core code, said core code being common to all services created by the method and supportive of DSL behavior parts and wherein for each component of telecom service created, a Java siplet is automatically created from the model and wherein the siplet is responsible for interacting with the telecom service environment and may create a state machine when applicable or forward events to an existing one.

### BRIEF DESCRIPTION OF THE DRAWINGS

FIG. 1 is a schematic depicting a Telecom service as a black box in accordance with an embodiment of the invention;

FIG. 2 is a high-level block diagram depicting a Meta-Model of a Telecom Service structure in accordance with an embodiment of the invention;

FIG. 3 is a high-level diagram depicting Invoking External Services in accordance with an embodiment of the invention.

FIG. 4 is high-level diagram depicting Event Types in accordance with an embodiment of the invention;

FIG. 5 is a high-level diagram depicting a Notification Service Main State Machine in accordance with an embodiment of the invention;

FIG. 6 is a high-level diagram depicting “Accept Event” types in accordance with an embodiment of the invention;

FIG. 7 is a high-level diagram depicting “Subscribing Client” State “do” activity in accordance with an embodiment of the invention;

FIG. 8 is a high-level diagram depicting Types of Send Signal Action in accordance with an embodiment of the invention;

FIG. 9. is a high-level diagram depicting a “Service Invocation Action” in accordance with an embodiment of the invention;

FIG. 10 is a high-level diagram of an “Extensions of OpaqueAction node” in accordance with an embodiment of the invention;

FIG. 11 is a high-level diagram of “Types related to loop modeling extensions” in accordance with an embodiment of the invention;

FIG. 12 is a high-level diagram depicting “Extension of the UML ReadSelfAction node” in accordance with an embodiment of the invention;

FIG. 13 is a high-level diagram depicting Extended Type for Telecom Model Library elements creation in accordance with an embodiment of the invention;

FIG. 14 is a high-level diagram depicting Telecom Model Library structure in accordance with an embodiment of the invention;

FIG. 15 is a high-level diagram depicting Common Data Types and their relations;

FIG. 16 is a high-level diagram depicting Time Related Types in accordance with an embodiment of the invention;

FIG. 17 is a high level diagram depicting Telecom Errors in accordance with an embodiment of the invention;

FIG. 18 is a high-level diagram depicting Supportive Types in accordance with an embodiment of the invention;

FIG. 19 is a high-level diagram depicting Data Types related to Presence Services in accordance with an embodiment of the invention;

FIG. 20 is a high-level diagram depicting a State Machine Diagram of Basic Service Template in accordance with an embodiment of the invention;

FIG. 21 is a high-level diagram depicting a State Machine diagram of Call Management Service Template in accordance with an embodiment of the invention;

FIG. 22 is a high-level diagram depicting a State Machine diagram of a Subscribe/Notify Template in accordance with an embodiment of the invention;

FIG. 23 is a high-level diagram depicting a Media Player in accordance with an embodiment of the invention;

FIG. 24 is a high-level diagram depicting a Unit Converter in accordance with an embodiment of the invention; and

FIG. 25 is a flowchart depicting a method for the development of Telecom Services in accordance with an embodiment of the invention.

### DETAILED DESCRIPTION

The method of the invention is embodied in an IDE based on TS-DSL. TS-DSL is a UML extension for the telecom domain and is a language for defining Telecom services such as IP Multimedia Subsystems (IMS) Services abstracting over telecom domain specific architectures and protocols such as IMS, SIP, Diameter, SDP, etc.

This language is intended to be used by modelers who may or may not have telecom domain knowledge. In this regard, TS-DSL allows a user to model and create a telecom service in abstract form while hiding internal details from modelers thereby providing high level building blocks for designing Telecom Services. The service model building process is based on predefined types of services (partial models and templates) that the user selects for his newly created service model. Once a template type is selected, the user first configures its properties as required. The desired elements of the model are then generated. The model created by the framework of the template selected will contain predefined elements including state machines and activities describing service behavior, a service specification as a black box and an additional placeholder for implementing the service as a white box.

Extending and modifying this initial model, a user can specify details of service behavior using a combination of state machines and Activity charts. Any model that complies with the validation rules will be transformed into code including its behavior. This transformation comprises an algorithm that maps both structural and behavioral elements of the Activity and State machine diagrams (like call and behavior actions and state and transitions) into executable Java code and other elements needed to create Telecom service based on the model. In this regard no human intervention is needed at the code level. All the required programming information is contained within the Telecom model which is at a higher level of abstraction than the application code. The TS-DSL enables modelers to define both the static and dynamic aspects of a Telecom Service. For this, it utilizes UML2 and IBM's “UML Profile for Software Services”; refining and extending it for the telecom domain. While an embodiment of the method is directed to IMS telecom services, IMS support is an extension to core telecom services support and other extensions can also be defined. In an embodiment, TS-DSL is implemented as an overlay to IBM's rational tool, RSA. A description of TS-DSL and its features now follows.

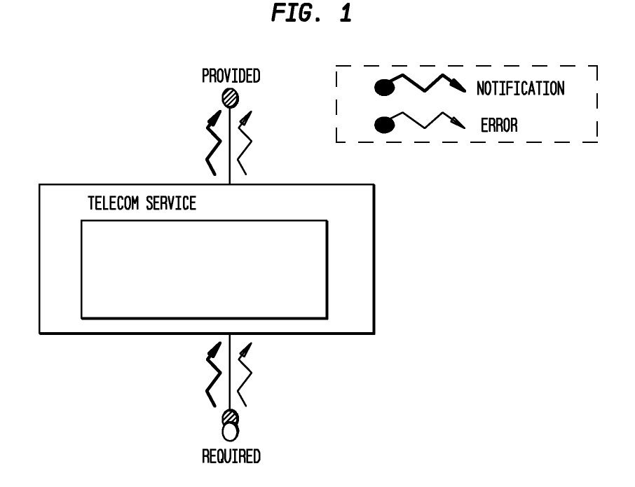

In Service Oriented Architecture, (SOA) a service (defined by IBM's “UML Profile for Software Services”) is a black box defining only the interfaces through which the outside world can communicate with it (known as Provided Interfaces) and what it requires from other services in order to operate as expected (known as Required Interfaces). This representation enables distinguishing a service representation from its implementation. In contrast to other service types, and as depicted in FIG. 1, Telecom Services require additional features in order to provide a meaningful abstraction over IMS Service communication patterns. These additional features include:
1. Ability to send notifications to other services/clients
2. Ability to accept and handle notifications from other services/clients
3. Ability to define what errors it might send out to its clients
4. Ability to define what errors it may be required to handle (send from the environment or used services)

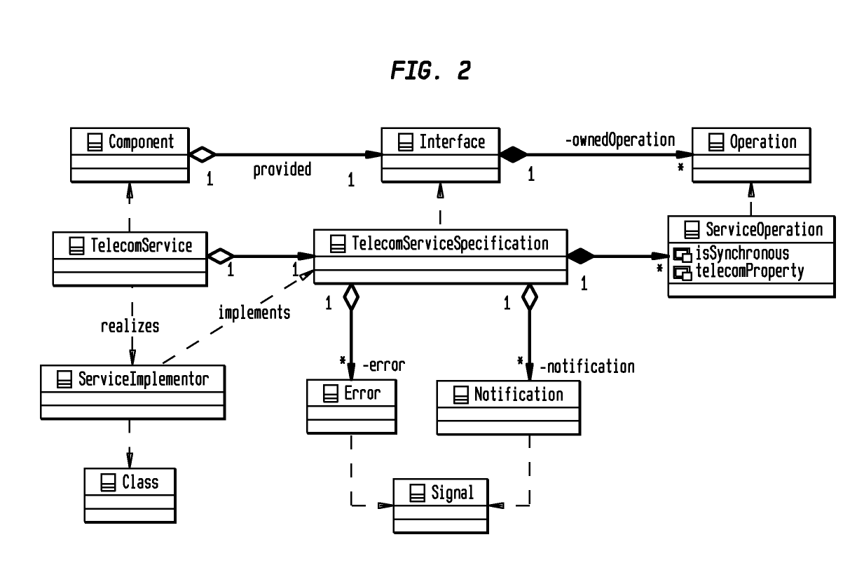

To provide these features in TS-DSL, the following elements, also depicted in FIG. 2 are defined:
1. TelecomService (extending Service): a service that interacts with the world via Operations, Notifications, and Errors.
2. Notification (extending Signal): A Signal that may be used to notify a client Service on some event. Typically sent out in Notification typed services following a subscribe routine. For example, one can define a SaleDetailsNotification which is sent out to registered clients when a store is having a sale.
3. TelecomError (extending Signal): A signal indicating that an Error has occurred in the system and that may require handling. E.g.: NetworkFailureError, RequestRefusedError.
4. TelecomServiceSpecification (extending ServiceSpecification): An Interface that exposes a set of operations that can be used to activate the service (if used as a provided interface) and operations through which the service is expected to use others (if used as a required interface). In addition it includes a list of Notifications and a list of Errors. These lists define what notification/errors it may send out (provided) or may want/need to receive (required) depending on its role in the TelecomService.
5. ServiceOperation (extending Operation): An operation that exposes various characteristics of the potentially invoked service operation. Each TelecomService-Specification is expected to contain a non empty set of ServiceOperations. In the future other characteristics may be added.

Each ServiceOperation may have a set of parameters and return value. Some of the parameters can be tagged to specify an additional semantic role. For this version we defined the following semantic roles:
1. Originator (extends Parameter)—indicating that the parameter includes information on an originating service client
2. Target (extends Parameter)—indicating that the parameter includes information on an service initiated target

To simplify the service modeling, the Telecom Service Creation Environment allows a designer to create a new TelecomService based on an existing template or customizing existing models. In such a case, the service initial structure is generated automatically according to the template, thus providing the designer with a better starting point.

To further simplify the modeling task, TS-DSL defines a set of commonly used TelecomErrors and Notifications that can be used as-is in the service model. These elements are stored in the Telecom Model Library. In any case, designers can introduce proprietary Notifications and TelecomErrors within their model by stereotyping Signals accordingly.

A Telecom Model Library (discussed below) includes a set of predefined commonly used Errors and Notifications that can be used as-is by designers. Designers can introduce proprietary Notifications and Errors within their model by stereotyping their Signals accordingly. While UML provides support for errors, in TS-DSL an implicit type of Signal named “Error” is introduced. In TS-DSL, errors can be thrown from operation execution (specified via Operation's ThrownExceptions list) and by the service it self (defined via the provided TelecomServiceSpecification).

The Telecom Service domain is event oriented in nature since requests and responses are sent to and from a service in an asynchronous manner. This can require synchronization support in the behavioral model, which can be difficult in some cases. To simplify this for modelers, TS-DSL allows a user to specify whether TelecomServiceSpecification Operations are synchronous or asynchronous in nature. Thus, if an operation is classified as Synchronous and it is activated from within the behavior model, then underlying transformations will be responsible for adding synchronization support instead of the modeler at design time. To support this in the profile, ServiceOperation contains the “is Synchronous” attribute depicted in FIG. 2 which has a Boolean value true or false:
1. Asynchronous Operations: regular request where the service sends out a request and does not wait for a response.
2. Synchronous Operations: a request that the service sends out and then waits to get a completion response from (usually carrying data). Here, transformations produce the code to handle it.

The Service Creation Environment (SCE) allows designers to define a telecom Service and specify how it interacts with external services from different platforms. The main idea is to hide the platform details of ExternalService TelecomServiceSpecification, ServiceOperations, Notifications, TelecomErrors and Data types.

When a Service model is created, a Service Structure Diagram is created within it to define its relationship to external services. To locate services, TS-DSL uses a Service registry. Using the service registry a user can lookup a service and get information on it. When the modeler decides to import a service from the registry an ExternalService instance is created accordingly and is placed in a special package named “External Services”. An ExternalService is a type of “read-only” Component (seen as “black box”) thus only its provided TelecomServiceSpecification is exposed. It is defined with a few attributes (that are not exposed for modification to the designer) indicating on its ID in the service registry and the exact time it was imported. This information is used by the Service Creation Environment to assure that the transformed ExternalService content is up-to-date with the latest version of the service in the registry. All of the External service implementation details and binding information are hidden from the modeler.

In order to invoke an external service from an Activity, we defined the ServiceInvocationAction (for more info see next sub section). When creating this Action, the designer is expected to select an external service provided interface Operation that he wants to invoke. Following which, the input and output pins of the action will be updated to match the signature of the chosen Operation.

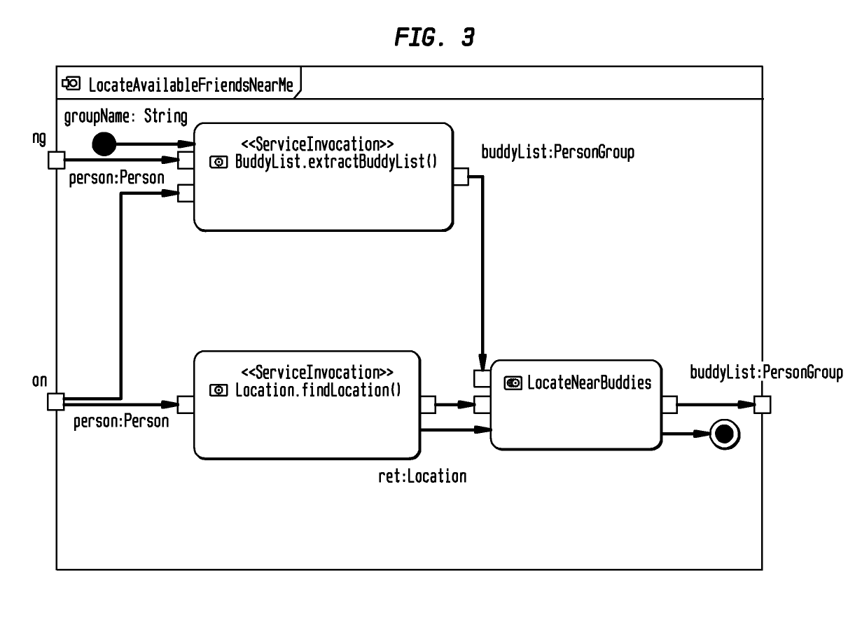

For example, FIG. 3 shows an Activity with a two ServiceInvocationAction instance that specifies the invocation of the findLocation( ) Operation of the Location Service and extractBuddyList Operation of the BuddyList Service. The Actions input and output pins (quantity and correlated types) are based on the Operation signatures, thus for example the findLocation( ) action accepts a Person and returns a Location. In this manner Service Choreography is achieved using service invocation points within the service behavior, while all the complex protocols, communication, and other low level details are hidden from the modeler but utilized in the transformation process.

Service behavior refers to how the different Service parts interact, what elements activate what functionality under particular conditions, when external services are invoked, etc. In TS-DSL, concrete constructs are introduced that can be used in the behavioral model, particularly in state machines and activities, to define as fully as possible the behavioral aspects of a telecom service. These constructs are taken as input in the transformation process and quality executable code is produced from them.

### Defining Telecom Service Behavior

Each Telecom Service is created with a main Statemachine. In it the modeler is required to specify the service interaction with the external world (service side). In TS-DSL, the movement from State to State in a Telecom Service can be initiated for the following reasons:
1. A Service Invocation request arrived: meaning that a call was made to one of the Services Provided Interfaces Operations.
2. A Notification Signal arrived: meaning that an external service/client sent an indication to the service that some event occurred
3. A TelecomError signal arrived: meaning that some unexpected situation occurred
4. Functionality of a previous state ended and no specific trigger specified on the transition (wildcard)

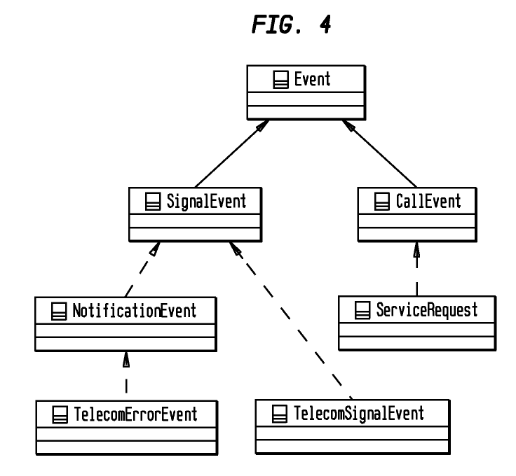

In all cases, the constraints on the transition need to be met in order for the flow to pass through it to the next stage. To capture this in the profile, TS-DSL defines the following events depicted in FIG. 4:
1. ServiceRequest (extends CallEvent): indicating that a request to activate a service provided operation arrived
2. NotitificationEvent (extends SignalEvent): indicating that a Notification arrived
3. TelecomErrorEvent (extends SignalEvent); indicating that a TelecomError arrived. Note that on each of these events a constraint is defined to indicate that the type of Signal they point to is of the type related to them (e.g. Notification Event can point only to a Notification Signal, etc.).

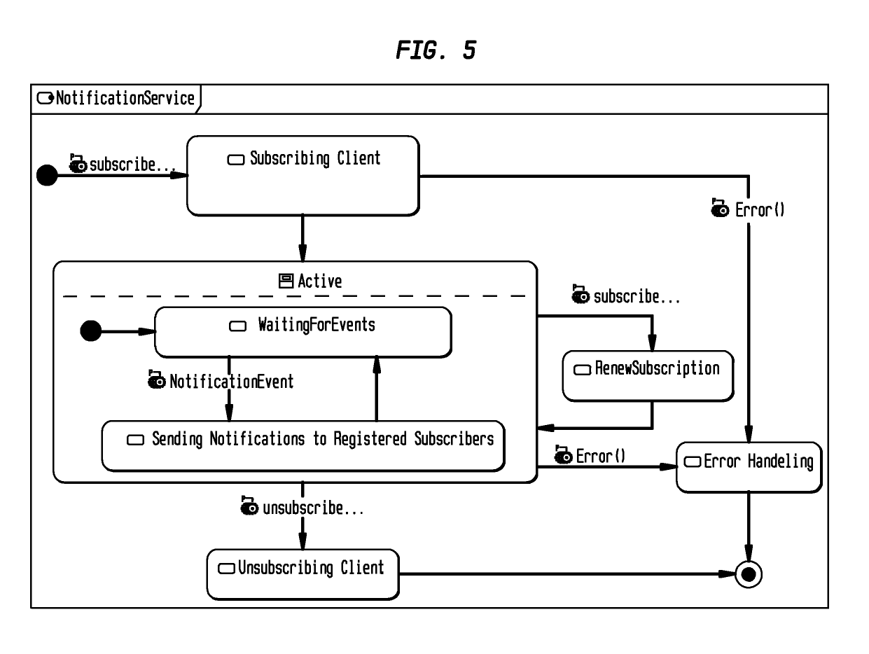

When designing the service main State Machine the modeler needs to define States and Transitions between them. In many cases the modeler can decide to create a new service using a service template which generates an initial Statemachine automatically for him. This reduces the amount of design work needed at this point. An example of such a Statemachine can be seen in FIG. 5, In it subscribes and unsubscribe( ) are Service Invocation requests, NotificationEvent indicates that a Notification Signal arrived, and Error( ) represents a TelecomErrorEvent indicating that TelecomError is thrown. Note that using the general TelecomErrorEvent means that any type of Error that arrives is caught by this transition.

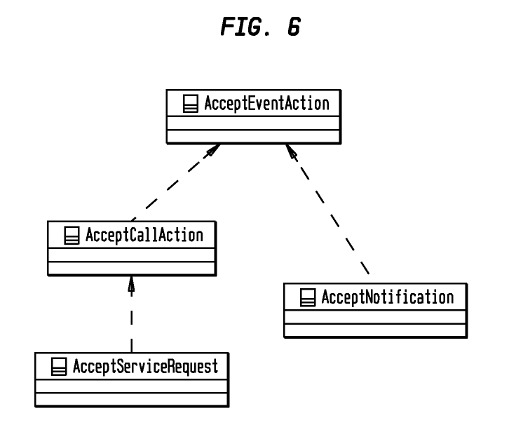

In order to aid designers in passing trigger information into the “do” Activity and implicitly indicating what caused the arrival to the state, the following AcceptEventActions depicted in FIG. 6 are defined:
1. AcceptServiceRequest (extending AcceptCallAction): specifying the handling of a request to activate logic related to a Service provided interface Operation. The Action's output pins represent the passed operation invocation data and match the related Operation signature.
2. AcceptNotification (extending AcceptEventAction): specifying the handling a Notification sent out. The Notification instance may also contain data. Errors are handled via the AcceptExceptionAction defined within UML.

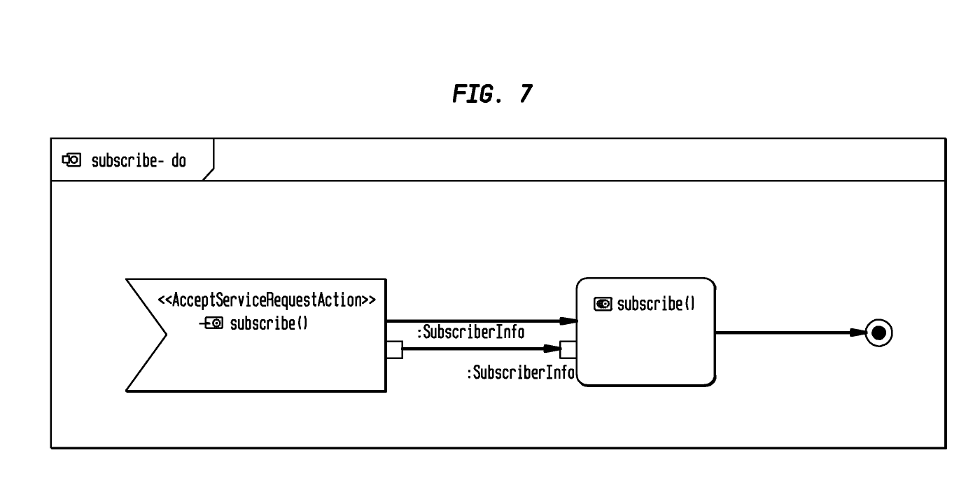

When a trigger is placed on a transition pointing to an instance of one of the aforementioned Events depicted in FIG. 4, SCE automatically updates its “do” activity to include a corresponding Event and AcceptEventAction descendant. This is done to help define the internal logic of the “do” Activity, in particular specifying the actual reason for the arrival and the passed data. For example, in FIG. 7, the AcceptServiceRequest was created automatically by the SCE passing the subscribes call data through its output pins. Thus the designer only needs to direct the SubscriberInfo data to a Service implementation class instance operation that is responsible to handle it. In any case, modelers are free to delete these Actions and use a regular Initial node if applicable when they want to specify the same behavior for all cases—regardless of data.

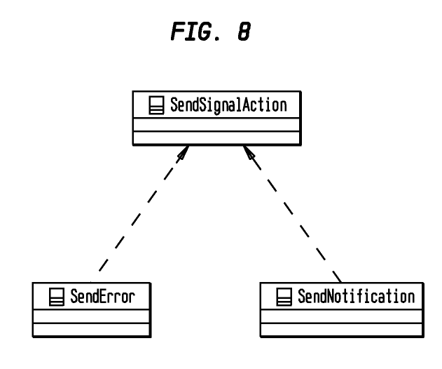

At any point in the Activity's logic, the modeler can also design sending (or broadcasting) a Notification. For this we defined the SendNotification (extending SendSignalAction) as seen in FIG. 8. This Action expects as a parameter a Notification instance and when control arrives to it, it sends out the Notification.

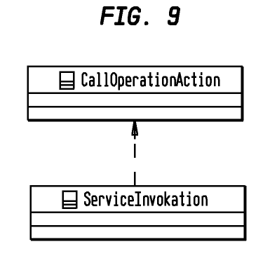

Modelers can activate an external service within the Telecom Service Model Activities. To support this in the profile, TS-DSL defines the ServiceInvocation (extends CallOperationAction) as seen in FIG. 9. The operation being called must be an external service provided interface ServiceOperation. Once selected, the input and output pins of the Action instance will be updated to represent the Operation signature.

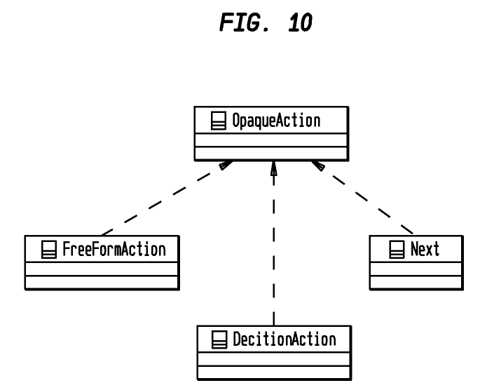

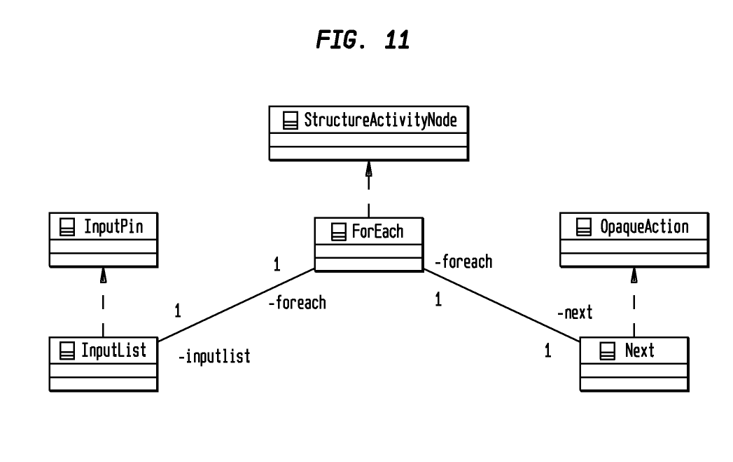

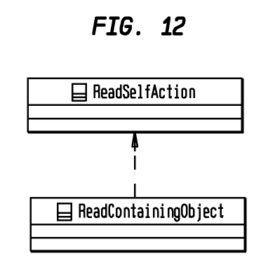

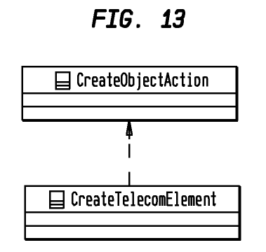

When designing a TelecomService, usually several logic fragments need to be designed. In this regard, TS-DSL includes a few control related Actions as depicted in FIG. 10:
1. FreeFormAction (extends OpaqueAction)—allows specifying snippets of Java code within an Action. The Action input and output pins are treated as variables. The advantage of this Action is that it allows designers to enter their own code when they rather not use UML Actions for this.
2. DecisionAction(extends OpaqueAction)—replaces UML's decision node by allowing to specify input to the decision. The decision constraint can use the action input pins as variables. We will consider removing this Action when RSM's support for decision node will mature.
3. Next (extends OpaqueAction)—this action is used together with ForEach action (see below) to provide the next target in the loop iteration process.
4. ForEach (extends StructureActivityNode)—represents a iterative loop. It is defined together with Next (defined above) and InputList (defined below)(see FIG. 11.
5. InputList (extends InputPin)—used as a part of ForEach action indicating that the ForEach Activity must have a single input of type List. The ForEach with iterate on the members of this list.
6. ReadContainingObject (extends ReadSelfActin)—this activity node was needed to fix a bug in RSM in the calculation of “self” object (see FIG. 12).
7. CreateTelecomElement (extends CreateObjectAction)—this action is used to indicate that a ‘TelecomModelLibrary’ element will be created (See FIG. 13)

### Model Libraries

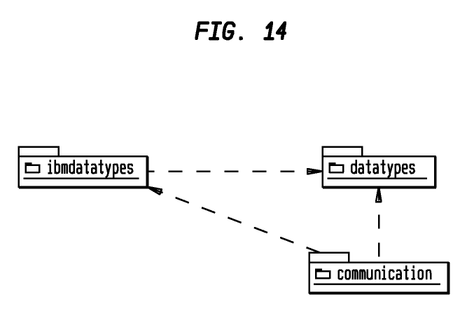

When implementing a DSL over UML, there are two accepted ways to introduce entities into the target model. One is via a profile (described above) and the other is by introducing model libraries. A Model Library is a model that can be referenced from the target model and cannot be modified by it. It includes sets of entities that can be used as-is or as base elements (extended via generalization) inside the model. In this section, various elements defined in the Telecom Model Library are described. Their top level packaging and dependencies are depicted in FIG. 14. Models created in the SCE automatically reference this model library and the telecom profile will also be applied to the model. The data types package allows designers to use predefined data types that are widely-used in Telecom service models, quickly and efficiently.

All types can be either used ‘as is’ in the newly-created services or extended with additional attributes and operations using UML Generalization relationship. Users can use UML primitive types, like String, Integer, etc. combined with Telecom library types when defining new composite data types for their service. The types defined here are derived from known standards, including Shared Information Data (SID) models that relate to TMF (TeleManagement Forum) working on eTOM and SID evolving standards.

### Common Data Types

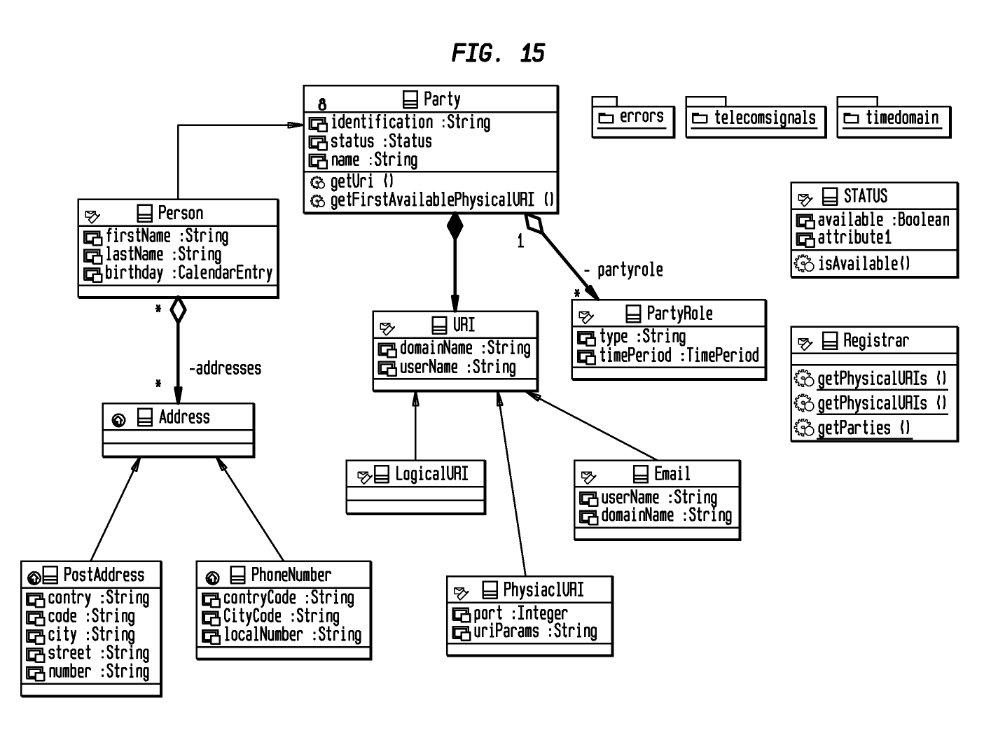

The following types depicted in FIG. 15, are defined as abstractions over typical data used in Telecom services. Some are related to the SID domains Party and Location and abstract over IMS data related concepts. The following paragraphs describe some of them.

### Time Related Types

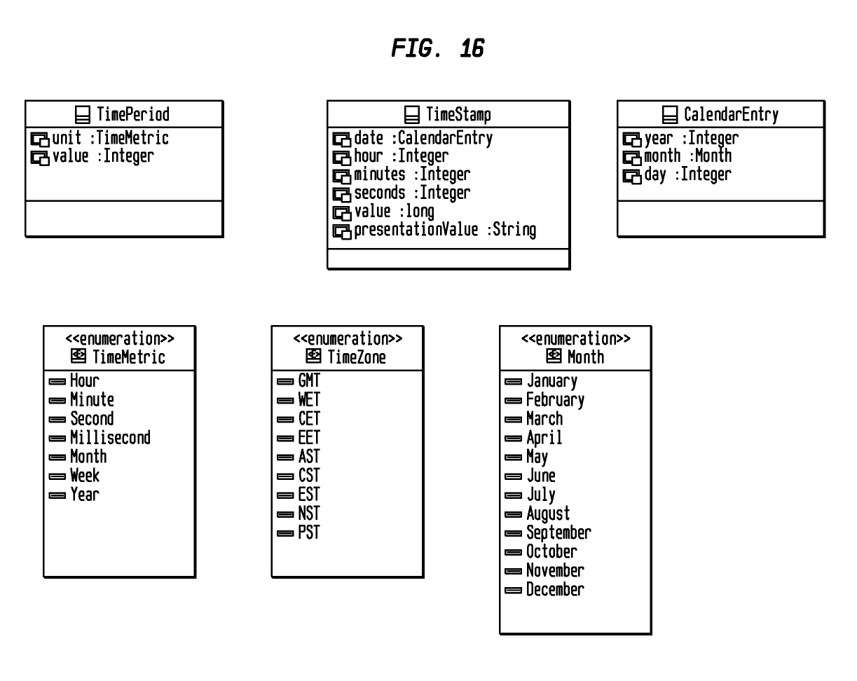

Time related types depicted in FIG. 16, are used for different aspects that provide functionality based on time interval, duration, frequency, etc, like the interfaces of a Presence server.

Errors, Notifications, and TelecomSignals

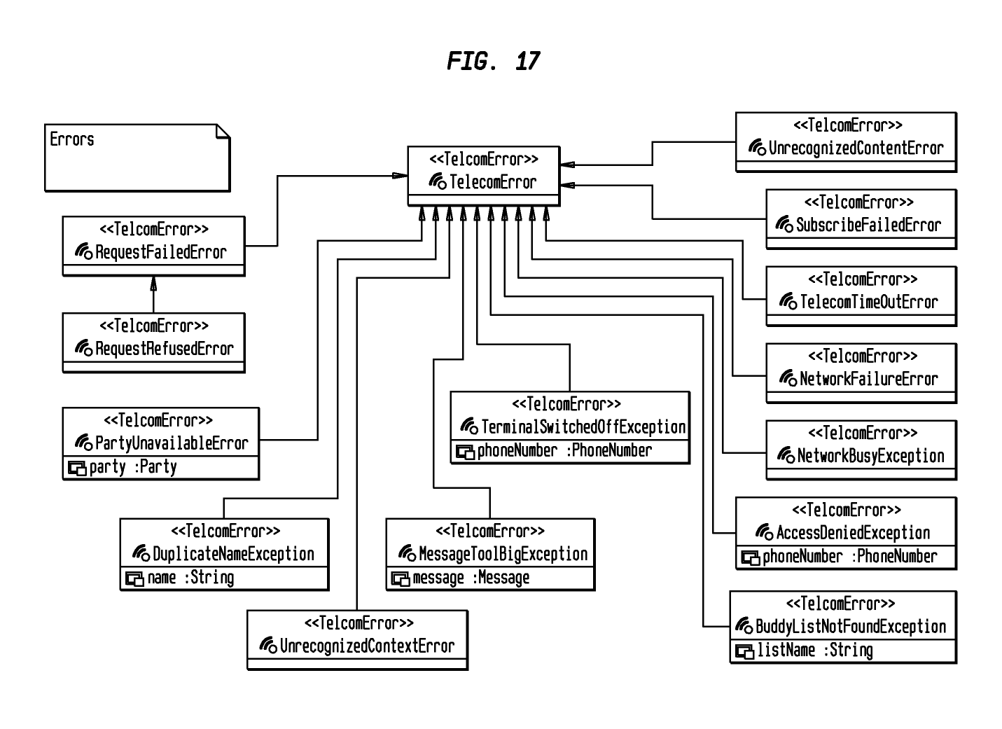

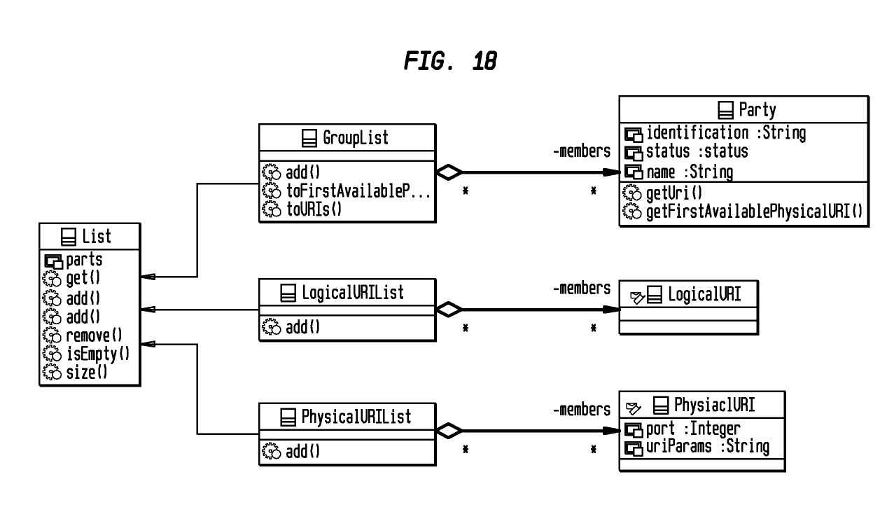

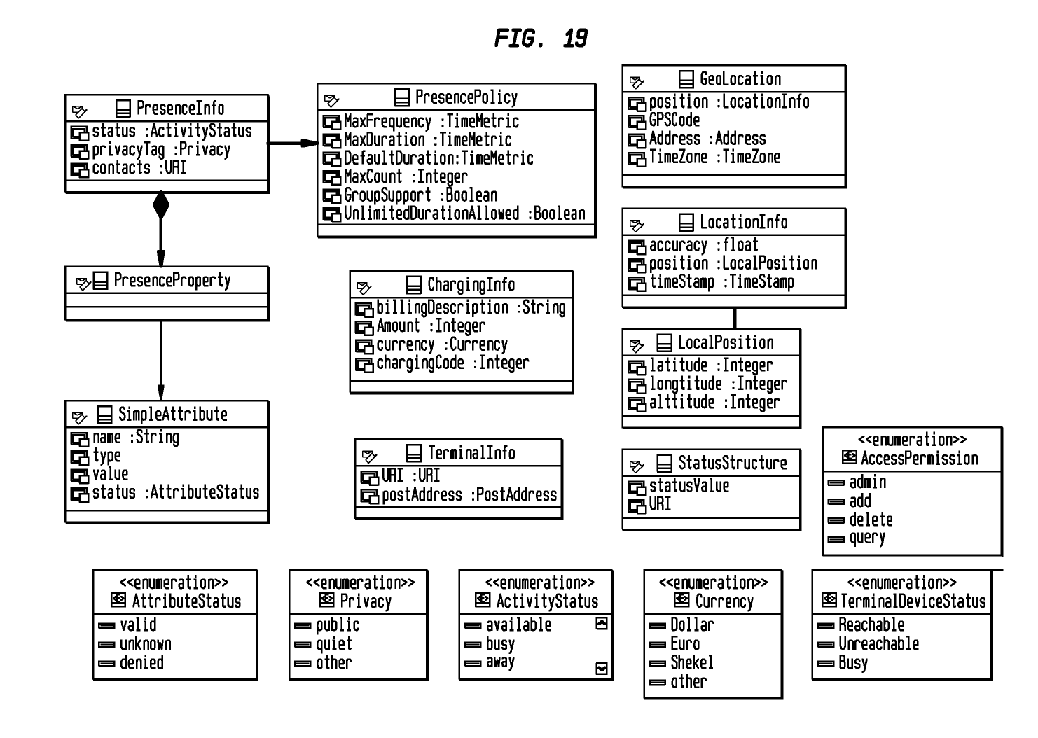

The library includes several types of commonly used Notifications and TelecomErrors. An initial set of TelecomErrors is seen in FIG. 17. By introducing these elements we provide the user with the means to manage telecom specific situations while maintaining a high level of abstraction. To ease designing of telecom services TS-DSL includes some supportive types to the library as shown in FIG. 18. Other data types and interfaces are shown in FIG. 19. These data types conform to the Parlay-X specification standard which is used in IBM's Presence server interfaces. In TS-DSL the data types allow its services to be invoked from within the model using the most important data involved in the format of a request and response parameters.

### Communication Library

The purpose of the TS-DSL Communication Library is to capture telecom related aspects in an object oriented manner that is both flexible and high level.

In TS-DSL, emphasis has been placed on modeling common telecom of communications, e.g. Call session and Instance Message. These communications interact with parties in order to communicate. For example, Instance message does so via messages sent to target clients, and Call does so by gathering a set of clients to a joined session.

Transformations operate in conjunction with the model library and generate code from its contents.

### Model Templates

In an embodiment, TS-DSL comprises of various service types that can be used as a starting point for service design and customized when necessary (set can be extended). When they are used as Model Templates, SCE creates a new Service that inherits from them with a special structure and content applicable for configuring it for the new service needs (e.g. initial state machine, implementation class and package structure).

The three types of services defined are:
1. Basic: clients only activate operations from its provided interface. The service does not keep information on the client—no state is kept.
2. Subscribe/Notify: similar to Basic but in addition clients can subscribe (via an operation) to get notifications from a service on different events. The service keeps information on its subscribing clients—unidirectional state tracking.
3. Call management: when the service is expected to manage Calls between ends and keep track of them—Bidirectional state management.

When creating a new service in the SCE we can select to create is based on one of these templates. When we do so, we are asked (via a set of wizard pages) to configure the template instance according to the service characteristics. Once we finish a new service is created with initial structure and content based on the template properties. This includes, among other parts, an initial state machine with states and transitions, implementation class and package structure. The state machines of the three templates defined above can be seen in the following subsections.

### 1. Basic Template

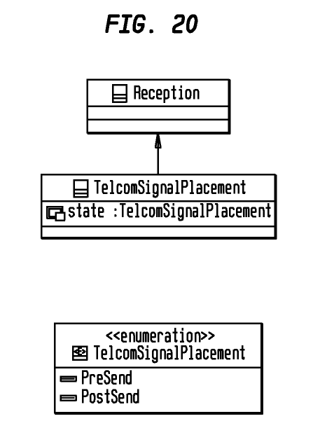

This template behavior is described by the State Machine presented in FIG. 20.

### 2. Call Management Template

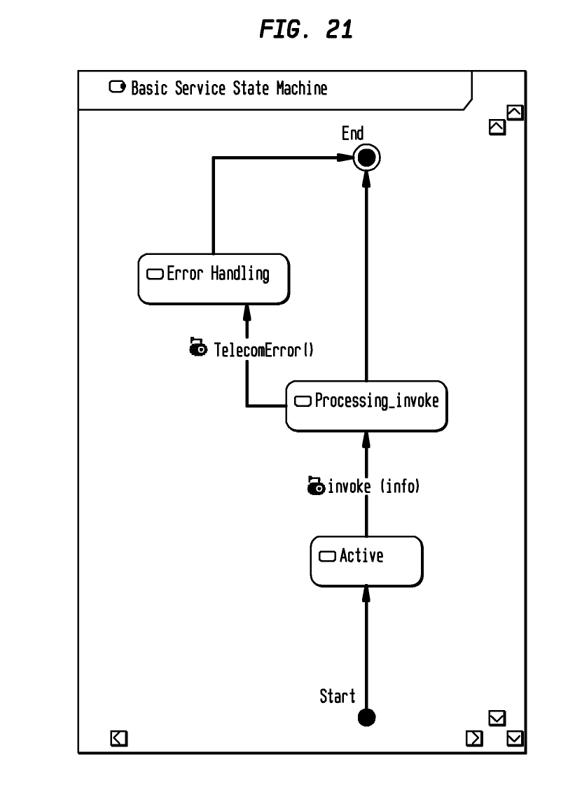

This template behavior is described by the State Machine presented in FIG. 21.

### 3. Subscribe/Notify Template

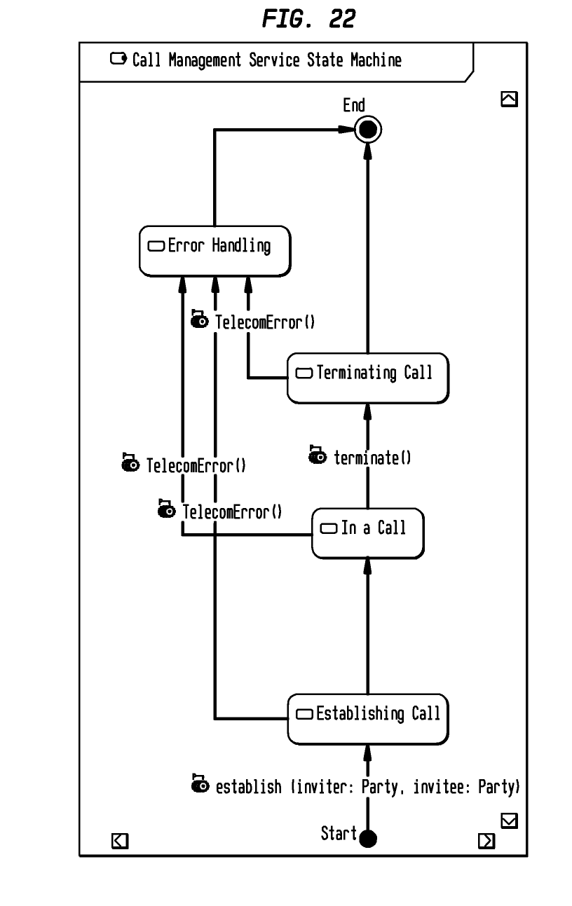

This template behavior is described by the State Machine presented in FIG. 22

### Reusable Constructs Library

The Service Creation Environment allows domain experts to introduce new entities into the modeling environment to be used by modelers when designing a telecom service. These entities are introduced into the SCE Reusable constructs Library. Modelers can inspect the library at any time and choose to instantiate any of the constructs available. When a domain expert introduces a new construct type into the library, he/she contributes information that may include:
1. Construct properties customization wizard and/or property view contribution
2. Indication of what type of UML model elements are used to represent it (aiding in classifying when it can be incorporated).
3. A figure that can be used for better visualizing it in the model
4. Instructions on how to incorporate it into the service transformed code. This can include information on how to transform it to executable code or instructions on how to access it at runtime.
5. Number of possible instances in a single Telecom Service model.

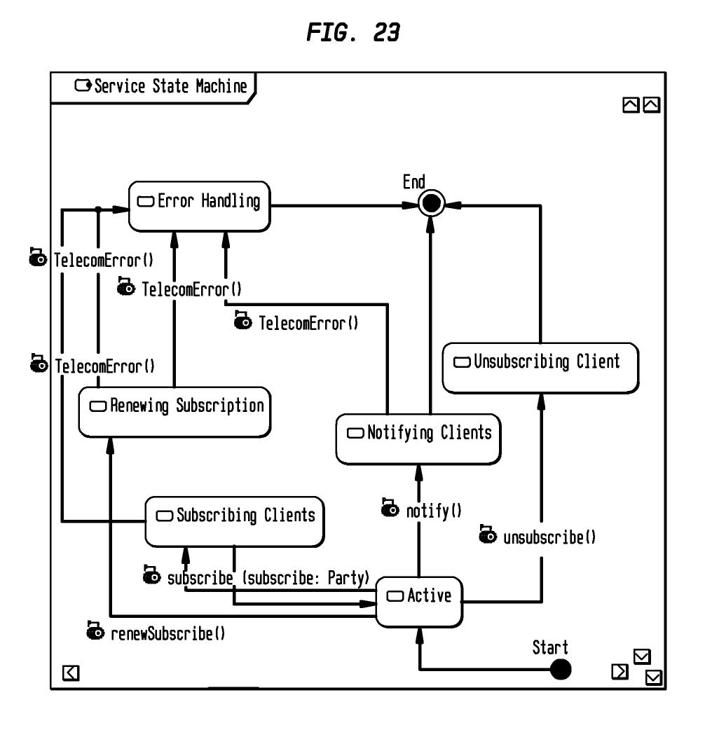

Examples of such entities are MediaPlayer and UnitConverter described below. Referring now to FIG. 23, a MediaPlayer is introduced into the service model as a local Service through which the telecom service can load Media and play, pause and stop it inside the context of a Call. Once the media stream ends, the modeler can also specify to resume it. If a Call is not established, errors will be thrown when trying to play or resume the media in it.

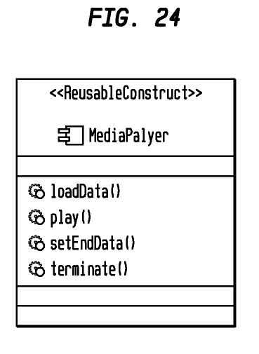

When working with external services, in many cases, the modeler may be faced with situations where the units of the data are different from the ones he/she expects or uses. For this reason TS-DSL defines a basic Unit Converter depicted in FIG. 24 that is introduced into the service model as a local Service and whose operations can be activated from within the Telecom Service Activities to transform data units. The Operation name specifies the converting it does.

### SUMMARY

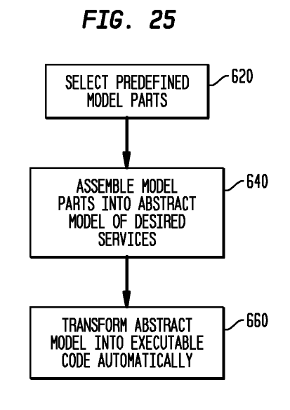

TS-DSL and its elements as described above comprise one embodiment of an IDE that designers and modelers can use as a tool to create telecom services. Using the elements discussed above, telecom services can be designed and implemented by creating a model of the services desired in abstract form and then transforming the abstractions into executable code. This method is depicted in FIG. 25. As depicted therein, the method of the invention is initiated by the selection of predefined models parts expressed in DSL in step 620. Once predefined model parts are selected in step 620, the predefined model parts are assembled into an abstract model in step 640. The abstract model created by the predefined model parts is then transformed into executable code in step 660.

It should be noted that the embodiment described above is presented as one of several approaches that may be used to embody the invention. It should be understood that the details presented above do not limit the scope of the invention in any way; rather, the appended claims, construed broadly, completely define the scope of the invention.

1. A method for programming telecommunications services comprising:
selecting predefined model parts related to specific services expressed in Domain Specific Language, wherein the Domain Specific Language is implemented as a Unified Modeling Language (UML) profile for telecommunications services, a telecommunications model library, and a set of reusable model constructs;
assembling the predefined model parts into an abstract model of desired telecom services; and
automatically transforming the abstract model of desired telecom services into an executable software program, wherein the automatically transforming step further comprises using a combination of code generated by the predefined model parts and of pre-compiled core code for the executable software program, and
wherein said core code is common to the desired telecom services created by the method and supportive of a Telecom Service Domain Specific Language that describes behavior of the predefined model parts,
wherein for each component of the desired telecom services created, a Java siplet is automatically created for the abstract model, and
wherein the Java siplet is responsible for interacting with a telecom service environment and creating a state machine.
